(19) United States
(12) Patent Application Publication
(10) Pub. No.: US 2017/0124139 A1
(43) Pub. Date: May 4, 2017

(54) Privacy Enforcement of Data Query Results.

(71) Applicant: International Business Machines Corporation, Armonk, NY (US)

(72) Inventors: ARIEL FARKASH, Shimshit (IL); IGOR GOKHMAN, Haifa (IL); ABIGAIL GOLDSTEEN, HAIFA (IL); SIMA NADLER, Kochav Yair (IL)

(21) Appl. No.: 15/203,822

(22) Filed: Jul. 7, 2016

Related U.S. Application Data
(63) Continuation-in-part of application No. 14/929,349, filed on Nov. 1, 2015, now abandoned.

(51) Int. Cl. G06F 17/30

(52) U.S. Cl. CPC G06F 17/30371; G06F 17/30528; G06F 17/30554; G06F 17/3056

(57) ABSTRACT

A data processing method is provided including intercepting a data query for deriving data from a data set, intercepting data results of processing the data query, and processing the data results in accordance with a processing rule that specifies a processing action to be performed with one or more portions of the data results if a processing condition is met, thereby producing processed data results, wherein the processing condition is dependent on both a) information associated with the data query, wherein the information associated with the data query is ascertained independently from the data results, and b) information associated with the data results, wherein the information associated with the data results is other than the information associated with the data query.

### BACKGROUND

When a query is received by a data management system, consideration of privacy policies associated with the owners of the underlying data or by their custodians may be required when deciding whether to provide or withhold data in response to the query, and whether data are to be obfuscated or otherwise altered in any way before they are provided in response to the query.

### SUMMARY

In one aspect of the invention, a data processing method is provided including intercepting a data query for deriving data from a data set, intercepting data results of processing the data query, and processing the data results in accordance with a processing rule that specifies a processing action to be performed with one or more portions of the data results if a processing condition is met, thereby producing processed data results, wherein the processing condition is dependent on both a) information associated with the data query, wherein the information associated with the data query is ascertained independently from the data results, and b) information associated with the data results, wherein the information associated with the data results is other than the information associated with the data query.

In other aspects of the invention systems and computer program products embodying the invention are provided.

### BRIEF DESCRIPTION OF THE DRAWINGS

Aspects of the invention will be understood and appreciated more fully from the following detailed description taken in conjunction with the appended drawings in which:

FIGS. 1A and 1B, taken together, is a simplified conceptual illustration of a data privacy enforcement system, constructed and operative in accordance with an embodiment of the invention;

FIG. 2 is a simplified flowchart illustration of an exemplary method of operation of the system of FIGS. 1A and 1B, operative in accordance with an embodiment of the invention; and

FIG. 3 is a simplified block diagram illustration of an exemplary hardware implementation of a computing system, constructed and operative in accordance with an embodiment of the invention.

### DETAILED DESCRIPTION

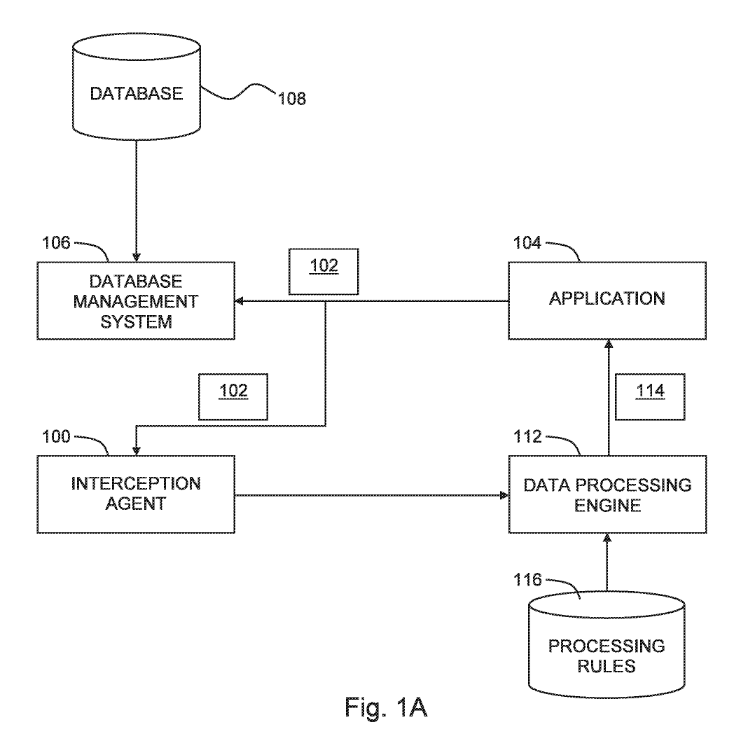

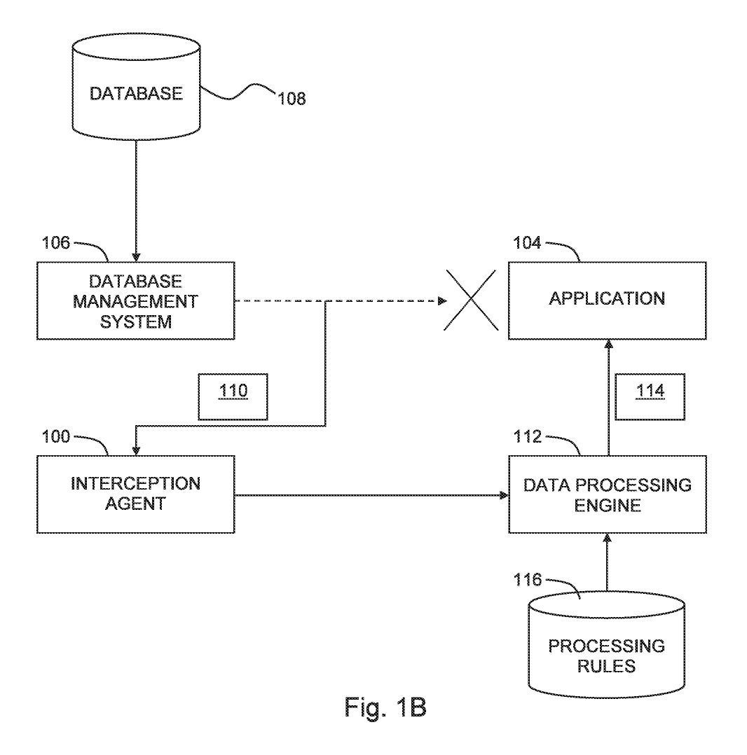

Reference is now made to FIGS. 1A and 1B, which, taken together, is a simplified conceptual illustration of a data privacy enforcement system, constructed and operative in accordance with an embodiment of the invention. In FIG. 1A, an interception agent 100, such as may be implemented using GUARDIUM S-TAP, commercially available from International Business Machines Incorporated of Armonk, N.Y., U.S.A., is configured to intercept a data query 102, such as may, for example, be issued by a software application 104 to a database management system (DBMS) 106, for deriving data from a data set, such as may, for example, be stored in a database 108. Interception agent 100 is configured to analyze data query 102 to ascertain information associated with data query 102. Examples of such information associated with data query 102 include identifiers of tables, columns or objects that are to be accessed when DBMS 106 processes data query 102, information regarding when and how these items are to be named in the results of processing data query 102, as well as contextual information such as the identity of software application 104, the identify of a user associated with data query 102, the time that data query 102 was issued, and the universal resource locator (URL) or internet protocol (IP) address from which data query 102 was issued.

In FIG. 1B, interception agent 100 is configured to intercept data results 110 that are the results of the processing of data query 102, such as where DBMS 106 processes data query 102 to derive data results 110 from database 108. Interception agent 100 is configured to intercept data results 110 before data results 110 are provided to any recipient to which data results 110 are intended to be sent, such as where the recipient is software application 104 that issued data query 102, and thereby prevent data results 110 from being provided their intended recipient. Interception agent 100 is configured to analyze data results 110 to ascertain information associated with data results 110, such as specific values returned within data results 110, including record identifiers, as well as the data values themselves, wherein the information ascertained from data results 110 is other than the previously ascertained information associated with data query 102 as described hereinabove with reference to FIG. 1A.

A data processing engine 112, such as may be implemented using GUARDIUM FOR APPLICATIONS, commercially available from International Business Machines Incorporated of Armonk, N.Y., U.S.A., is configured to process data results 110 after data results 110 are intercepted by interception agent 100, where data processing engine 112 produces processed data results 114 as follows. Data processing engine 112 evaluates one or more predefined processing rules 116, where each processing rule 116 specifies one or more processing actions to be performed with one or more portions of data results 110 if one or more processing conditions are met. Each processing rule 116 that is in accordance with the invention includes a processing condition that is dependent on both

information associated with data query 102, where the information associated with data query 102 is ascertained independently from data results 110, and

information associated with data results 110, where the information associated with data results 110 is other than the previously ascertained information associated with data query 102.

Processing actions specified by processing rules 116 may include modifying any of data results 110, withholding any of data results 110 from processed data results 114, or including any of data results 110 without modification in processed data results 114. Modifying any of data results 110 may, for example, include spell-checking or reformatting any of data results 110, or obfuscating any of data results 110, such as by masking any of data results 110 using any masking technique, such as by replacing any of any of data results 110 with randomly-selected characters, or with predefined characters such as asterisks, in processed data results 114. Data processing engine 112 preferably forwards processed data results 114 to any recipient to which data results 110 are intended to be sent, such as where the recipient is software application 104 that issued data query 102.

The system of FIGS. 1A and 1B is preferably implemented in computer hardware and/or in computer software embodied in a non-transitory, computer-readable medium in accordance with conventional techniques, and may be implemented within software application 104, within DBMS 106, or in a proxy that intermediates between software application 104 and DBMS 106.

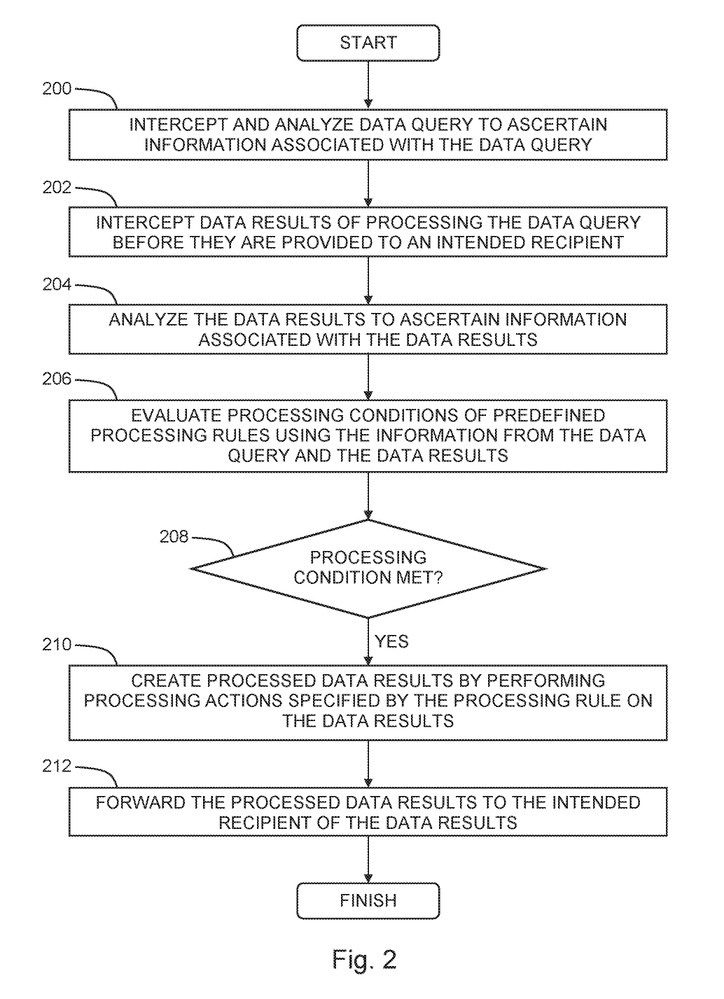

Reference is now made to FIG. 2 which is a simplified flowchart illustration of an exemplary method of operation of the system of FIGS. 1A and 1B, operative in accordance with an embodiment of the invention. In the method of FIG. 2, a data query is intercepted and analyzed to ascertain information associated with the data query (step 200). Data results that are the results of the processing of the data query are intercepted before they are provided to an intended recipient, thereby preventing the data results from being provided their intended recipient (step 202). The data results are analyzed to ascertain information associated with the data results (step 204). Processing conditions of predefined processing rules are evaluated using the information from the data query and the data results (step 206). If a processing condition of a processing rule is met, where the processing condition is dependent on both data query information and data results information (step 208) then processed data results are created by performing processing actions specified by the processing rule on the data results (step 210), and the processed data results are forwarded to the intended recipient of the data results (step 212).

Operation of the system of FIGS. 1A and 1B and the method of FIG. 2 may be illustrated with reference to the following examples of predefined processing rules, including their conditions and actions, where the processing conditions are dependent on both information associated with the data query and information associated with the data results produced by processing the data query, where the information associated with the data query is ascertained independently from the data results, and where the information associated with the data results is other than the information associated with the data query.

In one example, a predefined processing rule includes a condition that is dependent on the IP address from which the data query originated, as well as on the format of a date field in the data results, where the condition specifies that if the IP address is a European IP address, and the data results include a data field having a US date format (i.e., month/day/year), the action to be performed is to convert the date field data in the data results into a European date format (i.e., day.month.year) in the processed data results.

In another example, a predefined processing rule includes a condition that uses data query information to identify a service with which the data query is associates, as well as determine what data elements being queried and whether they include user identity information. If this part of the condition is met, the data results that are produced by processing the data query are then evaluated in accordance with the following conditions and acted upon as follows:

For each row of the data results

Extract from the row the identity of the user associated with the row
data
Check the user identity against user identities in a list of user data
consent contracts
If a user data consent contract is found for the user identity

For each data element in the row

Check the user's data consent contract to determine if
access is approved for this data element for the identified
service
If access is not approved,

exclude the data element from the row data in the
processed data results

else, if access is approved

If data masking is required,

mask the data element of the row data in the
processed data results

else, if no masking required,

include the data element of the row data in the
processed data results without modification

else, if no user data consent contract is found for the user identity

exclude the row from the processed data results.

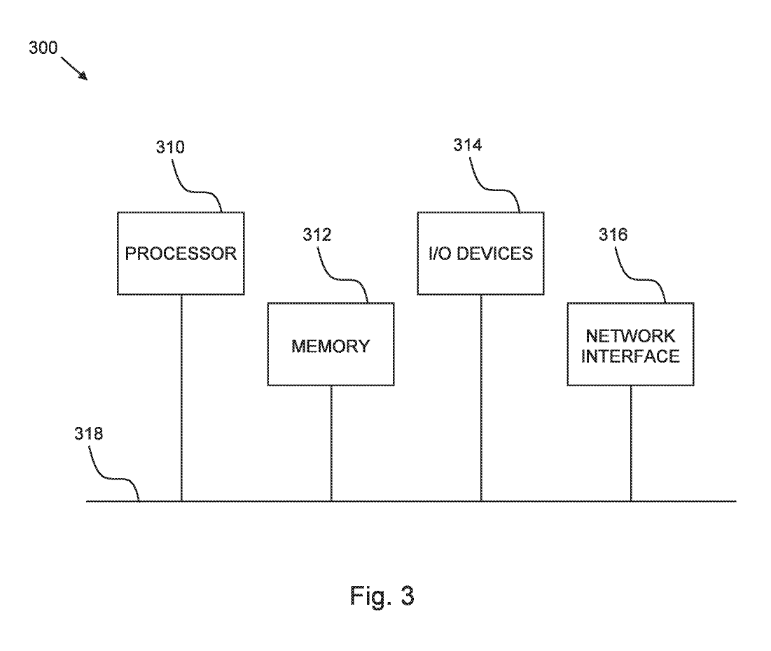

Referring now to FIG. 3, block diagram 300 illustrates an exemplary hardware implementation of a computing system in accordance with which one or more components/methodologies of the invention (e.g., components/methodologies described in the context of FIGS. 1A-2) may be implemented, according to an embodiment of the invention. As shown, the invention may be implemented in accordance with a processor 310, a memory 312, I/O devices 314, and a network interface 316, coupled via a computer bus 318 or alternate connection arrangement.

Embodiments of the invention may include a system, a method, and/or a computer program product. The computer program product may include a computer readable storage medium (or media) having computer readable program instructions thereon for causing a processor to carry out aspects of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Aspects of the invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A data processing method comprising:
intercepting a data query for deriving data from a data set;
intercepting data results of processing the data query; and
processing the data results in accordance with a processing rule that specifies a processing action to be performed with one or more portions of the data results if a processing condition is met, thereby producing processed data results, wherein the processing condition is dependent on both
a) information associated with the data query, wherein the information associated with the data query is ascertained independently from the data results, and
b) information associated with the data results, wherein the information associated with the data results is other than the information associated with the data query.

2. The method according to claim 1 wherein intercepting the data results comprises intercepting the data results
a) after the data results are derived from the data set, and
b) before the data results are provided to a recipient.

3. The method according to claim 1 wherein processing the data results comprises modifying any of the data results.

4. The method according to claim 1 wherein processing the data results comprises obfuscating any of the data results.

5. The method according to claim 1 wherein processing the data results comprises withholding any of the data results from the processed data results.

6. The method of claim 1 wherein the intercepting and processing are implemented in any of
a) computer hardware, and
b) computer software embodied in a non-transitory, computer-readable medium.

7. A data processing system comprising:
an interception agent configured to
intercept a data query for deriving data from a data set, and
intercept data results of processing the data query; and
a data processing engine configured to process the data results in accordance with a processing rule that specifies a processing action to be performed with one or more portions of the data results if a processing condition is met, wherein the processing condition is dependent on both
a) information associated with the data query, wherein the information associated with the data query is ascertained independently from the data results, and
b) information associated with the data results, wherein the information associated with the data results is other than the information associated with the data query.

8. The system according to claim 7 wherein the interception agent is configured to intercept the data results
a) after the data results are derived from the data set, and
b) before the data results are provided to a recipient.

9. The system according to claim 8 wherein the data processing engine is configured to modify any of the data results.

10. The system according to claim 8 wherein the data processing engine is configured to obfuscate any of the data results.

11. The system according to claim 8 wherein the data processing engine is configured to withhold any of the data results from the processed data results.

12. The system of claim 7 wherein the interception agent and the data processing engine are implemented in any of
a) computer hardware, and
b) computer software embodied in a non-transitory, computer-readable medium.

13. A computer program product for processing data, the computer program product comprising:
a non-transitory, computer-readable storage medium; and
computer-readable program code embodied in the storage medium, wherein the computer-readable program code is configured to
intercept a data query for deriving data from a data set,
intercept data results of processing the data query, and
process the data results in accordance with a processing rule that specifies a processing action to be performed with one or more portions of the data results if a processing condition is met, wherein the processing condition is dependent on both
a) information associated with the data query, wherein the information associated with the data query is ascertained independently from the data results, and
b) information associated with the data results, wherein the information associated with the data results is other than the information associated with the data query.

14. The computer program product according to claim 13 wherein the computer-readable program code is configured to intercept the data results
a) after the data results are derived from the data set, and
b) before the data results are provided to a recipient.

15. The computer program product according to claim 14 wherein the computer-readable program code is configured to modify any of the data results.

16. The computer program product according to claim 14 wherein the computer-readable program code is configured to obfuscate any of the data results.

17. The computer program product according to claim 14 wherein the computer-readable program code is configured to withhold any of the data results from the processed data results.
